(19) United States
(12) Patent Application Publication
(10) Pub. No.: US 2024/0208623 A1
(43) Pub. Date: Jun. 27, 2024

(54) LUNG DEMAND REGULATOR

(71) Applicant: DRAGER SAFETY AG & CO. KGaA, Lubeck (DE)

(72) Inventors: Gordon WRIGLEY, Newcastle Upon Tyne (GB); Paul James RINGER, Co. Durham (GB); Robert MILLER, Whitley Bay (GB)

(21) Appl. No.: 18/528,002

(22) Filed: Dec. 4, 2023

(30) Foreign Application Priority Data
Dec. 22, 2022 (EP) 22216092.1

(51) Int. Cl. B63C 11/14

(52) U.S. Cl. CPC B63C 11/14

(57) ABSTRACT

There is disclosed a lung demand regulator for a breathing apparatus comprising: a flow regulation mechanism having a closed configuration; a connection mechanism for releasably connecting the lung demand regulator to a face mask; and a lockout mechanism for locking the flow regulation mechanism in the closed configuration, the lockout mechanism configured to be activated by at least one release element, the movement of the at least one release element being translated to the lockout mechanism via a cam element and cam follower arrangement. Also disclosed is a face mask comprising a lung demand regulator and a breathing apparatus comprising a lung demand regulator.

### CROSS-REFERENCE TO RELATED APPLICATIONS

This application claims priority to European Application No. 22216092.1, filed on Dec. 22, 2022, the entire contents of which being fully incorporated herein by reference.

This disclosure relates to lung demand regulators for breathing apparatus and, more specifically to lung demand regulators for self-contained breathing apparatus.

### BACKGROUND OF THE INVENTION

Breathing apparatus commonly comprises a lung demand regulator, which may also be known as a second-stage regulator. The lung demand regulator is configured to deliver breathing gas to the user at a suitable pressure for breathing. Lung demand regulators may be configured to permit a constant low flow of gas during use in order to maintain positive pressure in the breathing mask, thereby preventing ingress of the ambient gas into the mask. In order to conserve breathing gas, the user may need to disable the breathing gas flow when not required, such as when removing the mask. The additional user intervention required in known lung demand regulators can be problematic as users may forget to disable the breathing gas flow.

Therefore, it should be understood that it is desirable to provide improvements to demand regulators in relation to the conservation of breathing gas.

### SUMMARY OF THE INVENTION

According to a first aspect, there is provided a lung demand regulator for a breathing apparatus. The lung demand regulator may comprise a flow regulation mechanism for regulating a flow of breathing gas, the flow regulation mechanism having a closed configuration in which breathing gas flow can be substantially prevented. The lung demand regulator further comprises a connection mechanism for releasably connecting the lung demand regulator to a face mask and the connection mechanism comprises at least one moveable release element configured to be manually actuated by a user to release the connection mechanism. The lung demand regulator further comprises a lockout mechanism for locking the flow regulation mechanism in the closed configuration. The lockout mechanism is configured to be activated by the at least one release element. The lockout mechanism comprises a lockout actuator configured to activate the lockout mechanism. The at least one release element comprises a cam element and the lockout actuator comprises a cam follower configured to engage with the cam element, such that the lockout actuator is actuated by movement of the at least one release element.

The lung demand regulator may be intended for use with a self-contained breathing apparatus (SCBA), but it should be understood that the lung demand regulator may also have applications in other types of breathing apparatus, such as self-contained underwater breathing apparatus (SCUBA) and emergency escape breathing apparatus.

The flow regulation mechanism may be movable from a substantially closed position to a substantially open position or be movable to any point between the closed and opened positions.

The lockout mechanism may comprise one or more levers configured to be pivotable which may communicate a force from the at least one release element to the flow regulation mechanism.

The cam element and cam follower may be made from the same or different materials. The same or different materials may have a suitably low coefficient of friction to ensure the cam element and cam follower can slide past each other with suitably low resistance. The same or different materials may also be suitably resistant to repeated abrasive contact.

The at least one release element may be movable in a substantially radial direction relative to a longitudinal axis of an outlet port of the flow regulation mechanism.

The at least one release element may, for example, be a button on the outside of the lung demand regulator. The at least one release element may be operated by the user pressing the at least one release element inwards radially towards the longitudinal axis.

The at least one release element may be biased so as to return to its inactive position once the user releases the at least one release element. If configured to be biased, the at least one release element may provide a suitably resistive force to the user to reduce the likelihood of accidental actuation by the user.

The substantially radial movement of the at least one release element may be translated into a movement of the lockout actuator in a direction substantially parallel to the longitudinal axis by the cam element and cam follower.

The cam element may be configured with a first chamfered face. The cam follower may be configured with a second chamfered face. The planes of the first chamfered face and second chamfered face may be substantially parallel to each other.

It should be understood that the cam element with a first chamfered face which, as a result of being driven towards the cam follower, which is optionally also configured with a second chamfered face, may cause the cam follower to move up along the first chamfered face. The cam follower may be suitably constrained to move along only one axis.

The first chamfered face may be configured with an angle substantially complementary to the angle of the second chamfered face so as to optimise the translation of force between the cam element and cam follower. The planes of the first chamfered face and second chamfered face may be substantially parallel.

The lung demand regulator may comprise two cam elements arranged to act in substantially opposing directions against the cam follower. Each cam element may be provided on a respective release element. The release elements may be actuatable in opposing directions. The release elements may be arranged on opposing sides of the lung demand regulator.

The lockout mechanism may comprise a lockout lever configured to be pivotable about a first pivot.

The lockout actuator may be configured to interface with the lockout lever such that movement of the lockout actuator pivots the lockout lever about the first pivot.

The lockout lever may be made from a material of sufficient rigidity to resist deformation during use. It should be understood that the lockout lever may also have a cross section configured to further increase the relative rigidity of the lockout lever, such as T-shaped, I-shaped, or U-shaped cross sections.

It should be understood that the lockout actuator may be configured to include a sealing element to substantially isolate the internal atmosphere from the ambient atmosphere, while still permitting the lockout actuator to be movable. The sealing element may comprise a groove around the outside of the lockout actuator and an O-ring partially inside the groove. The lockout actuator may be configured as a piston-like element, slidably moveable in a bore of the lung demand regulator.

The lung demand regulator may comprise a flow regulation lever configured to be pivotable about a further pivot.

The flow regulation lever may be configured to actuate the flow regulation mechanism. The flow regulation lever may be configured to contact a diaphragm of the lung demand regulator so as to be pivoted about the further pivot by movement of the diaphragm. The flow regulation lever may be configured to be locked by the lockout mechanism in a locking position in which the flow regulation mechanism is configured in the closed configuration.

The flow regulation lever may comprise a foot which contacts the diaphragm, causing the flow regulation lever to pivot about the further pivot as the diaphragm moves.

The lockout mechanism may further comprise a diaphragm retention lever configured to be pivotable about a second pivot. The diaphragm retention lever may be configured to contact the diaphragm and retain it in a position in which the flow regulation lever maintains the flow regulation mechanism in the closed position.

The lockout lever may be configured to interface with the diaphragm retention lever such that the pivoting movement of the lockout lever pivots the diaphragm retention lever about the second pivot.

The lockout actuator may be configured to interface with the lockout lever at a first position on the lockout lever at a first distance from the first pivot, and the lockout lever may be configured to interface with the diaphragm retention lever at a second position on the lockout lever at a second distance from the first pivot, wherein the second distance is greater than the first distance.

This configuration may compound a relatively small movement of the at least one release element into larger movements of the lockout lever and the diaphragm retention lever, so as to provide sufficient travel to move the diaphragm retention lever into the locking position. This compound lever arrangement may also reduce a force applied by the at least one release element to the lockout actuator to reduce the likelihood of damage occurring to the diaphragm or other components.

The lockout lever of the lung demand regulator may further comprise a stop element configured to prevent over-rotation of the lockout lever by contacting a section of the lung demand regulator body. The stop element may be positioned on the substantially opposite side of the first pivot to the main length of the lockout lever. It should be understood that the prevention of over-rotation of the lockout lever may prevent over rotation of the flow regulation mechanism. Undue tension on the diaphragm caused by possible over rotation of the flow regulation mechanism may also be substantially prevented.

The lockout mechanism may further comprise a locking element configured to hold the diaphragm retention lever in a fixed position corresponding to the closed configuration. The locking element may comprise a spring element. The force required to overcome the holding force of the locking element may be substantially equivalent to the force generated against the diaphragm retention lever by the diaphragm when the user inhales. Hence, the user may be able to deactivate the lockout mechanism by inhaling. The locking element may additionally or alternatively comprise a detent.

It should be understood that any pivots about which a component of the lung demand regulator may be configured to pivot may take any form, for example pivot joint, ball and socket joint, hinge joint, or plastic hinge.

The at least one release element may comprise a first keying element. It should be understood that the first keying element may be made from a material of sufficient rigidity to resist deformation during use.

The first keying element may comprise one or more protrusions and one or more depressions which are configured to complement a complementary second keying element on a face mask to which the lung demand regulator may be connected, enabling the lung demand regulator to latch or lock on to the face mask.

The first keying element may be configured to interface with a substantially annular second keying element on the face mask. It should be understood that the second keying element may comprise a cut-out of a substantially similar shape to the to the first keying element so to enable the first keying element to fit within the second keying element.

The first keying element and the second keying element may be configured to permit rotation of the lung demand regulator about the longitudinal axis relative to the face mask.

It should be understood that a profile cut-out substantially similar in shape to the first keying element, revolved around an axis to form a continuous annulus of the second keying element, may permit the first keying element to interface with the second keying element at any point around the circumference of the second keying element. It should, therefore, be understood that the lung demand regulator may be rotatable relative to the face mask about the longitudinal axis while remaining locked to the face mask.

The first keying element may comprise a chamfered section configured to contact the second keying element so as to automatically actuate the at least one release element when the lung demand regulator is pushed onto the face mask.

It should be understood that the force applied when pushing the lung demand regulator onto the face mask may actuate the at least one release element by converting the force substantially parallel with the longitudinal axis to a force substantially radial to the longitudinal axis via the interfacing of the chamfered section and the second keying element.

According to a second aspect, there is provided a breathing gas delivery system comprising a lung demand regulator according to the first aspect, and a face mask for connection to the lung demand regulator. The face mask may comprise a complementary connector for releasable connection to the connection mechanism of the lung demand regulator.

According to a third aspect, there is provided a breathing apparatus comprising a lung demand regulator according to the first aspect. The aspects described herein provide a mechanism for automatically disabling the flow of breathing gas through the lung demand regulator when the user connects or disconnects the lung demand regulator from the face mask, hence reducing the possibility of breathing gas being wasted when the lung demand regulator is not in use. The flow of breathing gas can be reenabled by the user inhaling through the lung demand regulator as normal. The automatic disablement of the breathing gas flow is achieved by translating the force applied to the at least one release element to the lockout mechanism, via the cam element and cam follower arrangement.

### BRIEF DESCRIPTION OF THE DRAWINGS

Arrangements of the invention will now be described, by way of example, with reference to the accompanying drawings, in which:

FIG. 1 schematically shows a breathing apparatus according to an example arrangement comprising a breathing mask and a lung demand regulator;

FIG. 2 schematically shows a breathing mask according to an example arrangement comprising a demand regulator;

FIGS. 3A, 3B and 3C schematically show cross-sectional views of a lung demand regulator in a closed configuration according to an example arrangement. The plane of the cross-sectional view shown in FIG. 3A is illustrated in FIG. 2 and the planes of the cross-sectional views shown in FIGS. 3B and 3C are illustrated in FIG. 3A;

FIGS. 4A, 4B and 4C schematically show cross-sectional views of a lung demand regulator in an open configuration according to an example arrangement. The plane of the cross-sectional view shown in FIG. 4A is illustrated in FIG. 2 and the planes of the cross-sectional views shown in FIGS. 4B and 4C are illustrated in FIG. 4A.

### DETAILED DESCRIPTION OF THE INVENTION

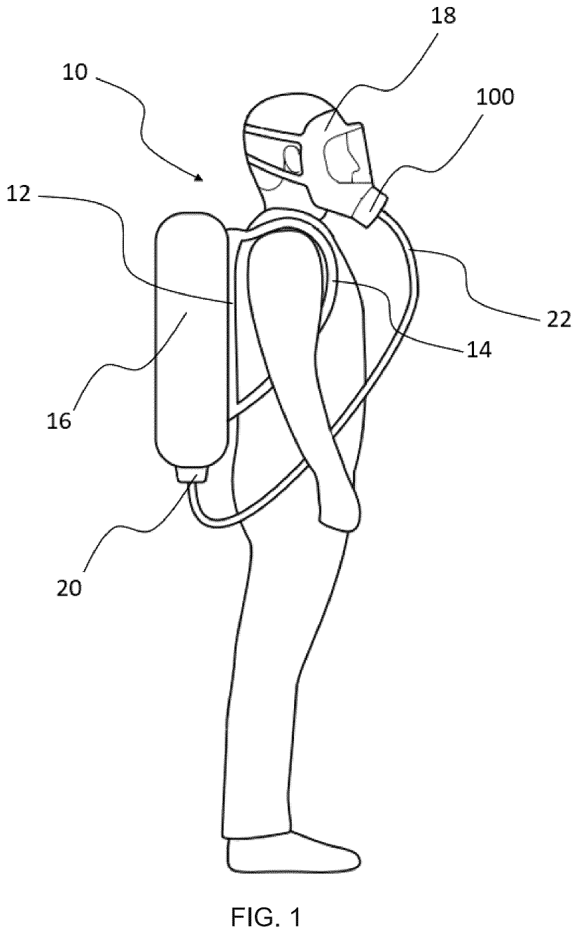

With reference to FIG. 1, an example breathing apparatus 10 is shown. The breathing apparatus 10 is a self-contained breathing apparatus (SCBA) and comprises a support frame or backplate 12, straps 14 for securing the SCBA to a user, a breathing gas cylinder 16, a face mask 18, a lung demand regulator 100 connectable to the face mask 18, and a pneumatics system 20 for delivering breathing gas from the cylinder 16 via a hose or flexible conduit 22 to the lung demand regulator 100, to thereby deliver breathing gas to the user wearing the face mask 18 on demand. The breathing apparatus 10 may further comprise other components or systems which are not shown, including but not limited to an electrical system, a monitoring system, or a communications system. The lung demand regulator 100 is referred to as the regulator 100 throughout.

In this illustrated arrangement, the breathing apparatus is a self-contained breathing apparatus (SCBA), but it should be understood that the lung demand regulator may also have applications in other types of breathing apparatus, such as self-contained underwater breathing apparatus (SCUBA) and emergency escape breathing apparatus.

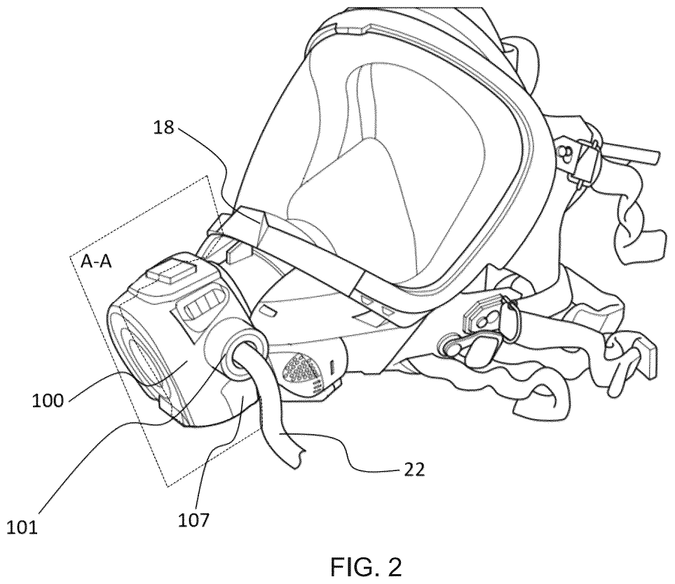

FIG. 2 schematically shows a face mask 18 attached to the regulator 100. As shown in more detail in FIG. 2, a hose 22 of the pneumatics system 20 is connected to an inlet 101 of the regulator 100 to provide breathing gas from the cylinder 16. The pneumatics system 20 may comprise a first-stage pressure reducer which reduces the pressure of the breathing air from the cylinder which may be stored at several hundred bar, to an intermediate pressure for provision to the regulator 100 via the hose 22. The intermediate pressure may be too high for the breathing gas to be provided directly to the user to breathe. The regulator 100 may further comprise a second-stage pressure reducer which further reduces the pressure of the breathing gas to a suitable pressure for delivery to the user to breathe. In other arrangements, more than two or fewer than two pressure reducers may be provided.

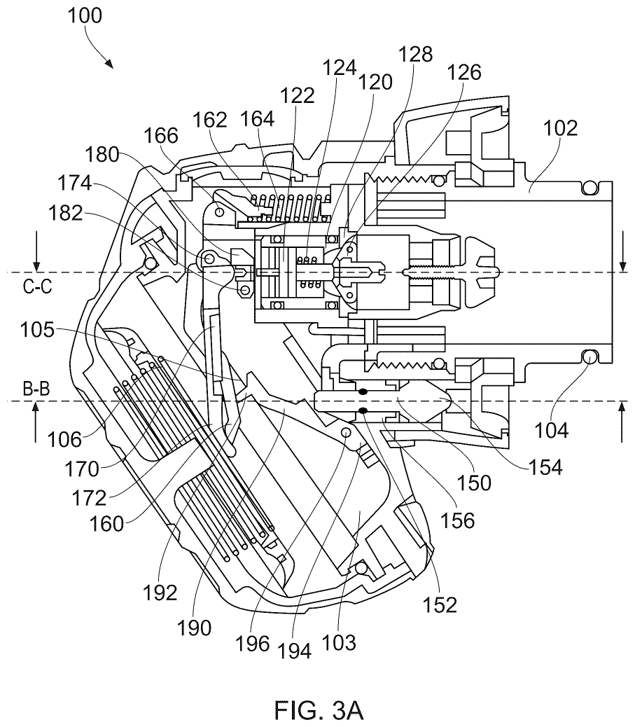

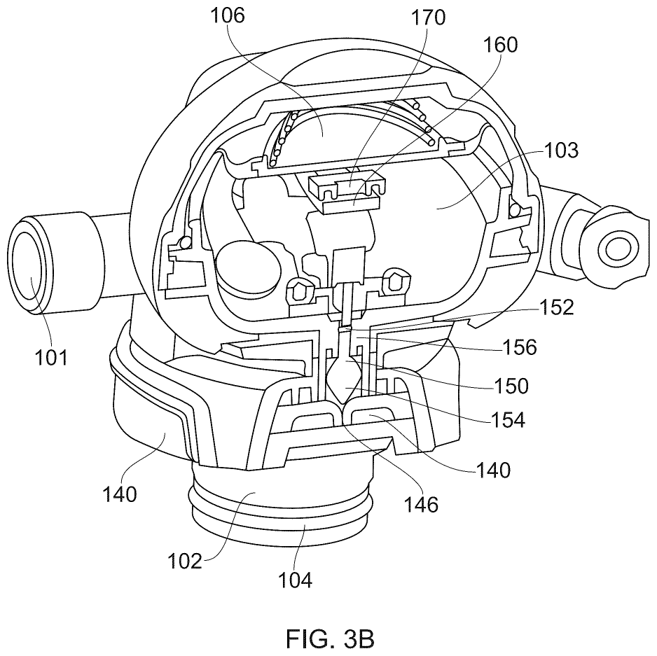

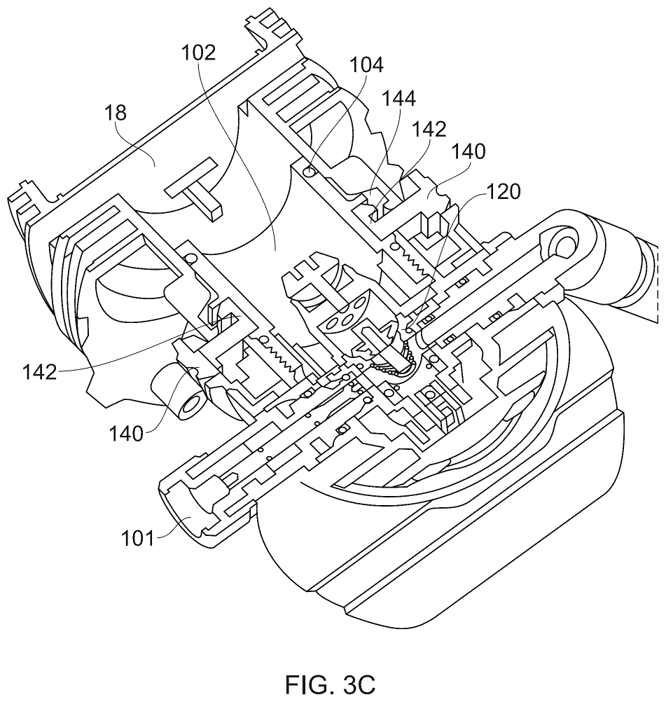

FIGS. 3A, 3B, and 3C schematically show the regulator 100 in more detail. FIG. 3A shows a cross-sectional view of the regulator 100 on the plane A-A shown in the FIG. 2. FIG. 3B shows a cross-sectional view of the regulator 100 on the plane B-B shown in FIG. 3A. FIG. 3C shows a further cross-sectional view of the regulator 100 on the plane C-C shown in FIG. 3A.

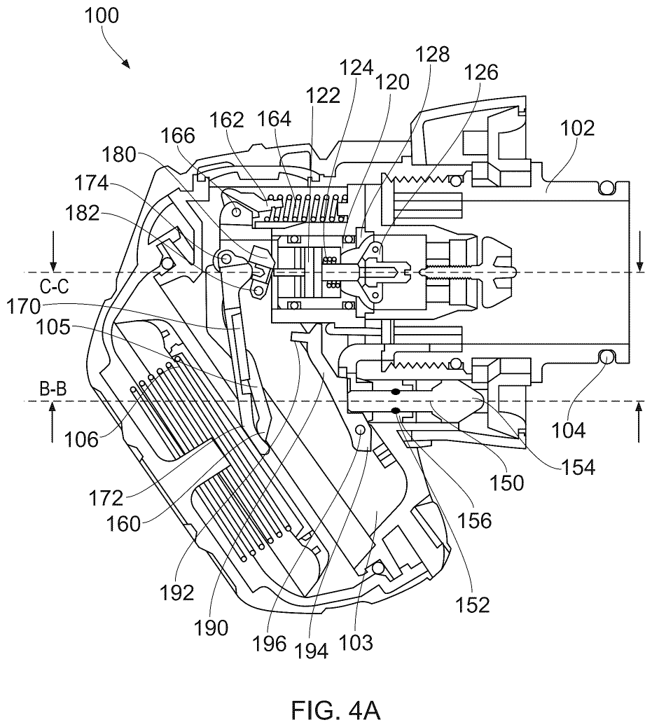

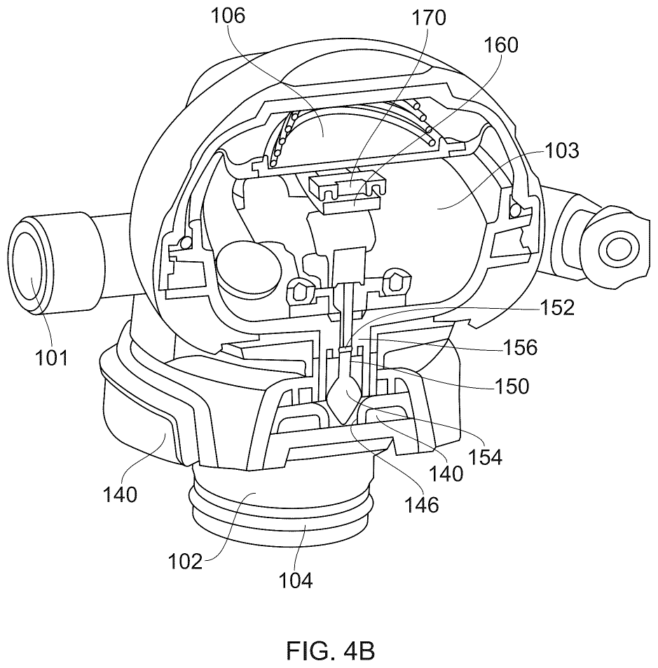

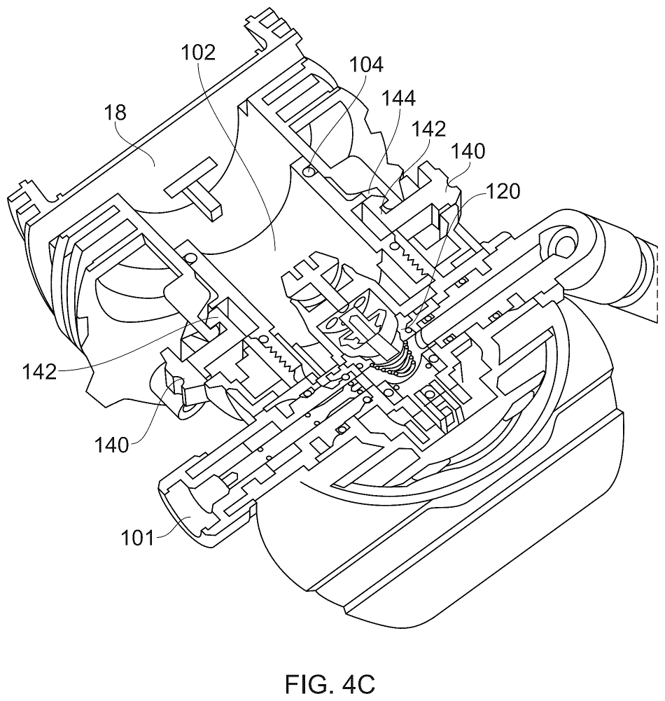

As shown in these FIGS. 3A-C, the regulator 100 comprises a flow regulation mechanism 120 for regulating a flow of breathing gas. In FIGS. 3A-C, the flow regulation mechanism 120 is shown in a closed configuration in which breathing gas flow is substantially prevented. The flow regulation mechanism 120 comprises a plunger 122, a spring 124, and a seal 126. When in the closed configuration, the seal 126 contacts a seal seat 128, thereby substantially preventing the breathing gas from flowing. An open configuration of the flow regulation mechanism 120 is illustrated in FIGS. 4A-C, as discussed further below. Identical features are labelled with the same references across FIGS. 3A-C and 4A-C.

The flow regulation mechanism 120 is actuated by the flow regulation lever 170 and the secondary lever 180. The flow regulation lever 170 includes a protrusion close to its pivot (the flow regulation lever pivot 174) which, as the flow regulation lever rotates in an anticlockwise direction, presses against the secondary lever 180, causing the secondary lever 180 to also rotate about the secondary lever pivot 182. The secondary lever 180 pushes against the plunger 122 of the flow regulation mechanism 120, causing it to move, lifting the seal 126 away from the seal seat 128. The further the flow regulation lever 170 rotates in an anticlockwise direction, the further the seal 126 will be lifted away from the seal seat 128, increasing the rate of flow of breathing gas.

The flow regulation lever 170, which comprises a flow regulation lever foot 172, is rotated as a result of movement of the diaphragm 106. The diaphragm 106 moves when there is a difference in pressure between the regulator chamber 103 and the ambient pressure.

Starting from a state where the flow regulation mechanism 120 is in the closed configuration and there is no breathing gas flowing, the user can inhale causing a drop in pressure in the regulator chamber 103 compared to the ambient pressure. The pressure differential causes the diaphragm 106 to move inwards. As the diaphragm 106 moves inwards, the flow regulation lever foot 172 is contacted by the diaphragm 106, causing the flow regulation lever 170 to rotate anticlockwise. The resulting anticlockwise movement is translated through the secondary lever 180 to the plunger 122, lifting the seal 126 off the seal seat 128. As a result, breathing gas can begin to flow. In many examples, this process will occur rapidly so as not to deprive the user of breathing gas as they inhale. In some configurations, the flow regulation mechanism 120 may be balanced such that, in a neutral position with no pressure differential across the diaphragm 106, the seal 126 is slightly separated from the seal seat 128 (i.e., a nearly-closed configuration) to provide a small constant flow of breathing gas to maintain positive pressure in the face mask 18, thereby preventing ambient gas ingress. FIGS. 4A-C show the flow regulation mechanism 120 in a more fully open configuration, such as when the user is inhaling.

Once the user stops inhaling, there is generally a pause before they begin to exhale. During this pause, breathing gas continues to flow through the flow regulation mechanism 120. The flowing breathing gas gradually increases the pressure inside the regulator chamber 103. The pressure further increases once the user begins to exhale. The pressure continues to increase until such point where the pressure in the regulator chamber 103 exceeds the ambient pressure, causing the diaphragm 106 to move outwards. As the diaphragm 106 moves outwards, the flow regulation lever foot 172 and thus the flow regulation lever 170 are no longer being held in place. Resultingly, the spring 124 inside the flow regulation mechanism 120 overcomes the forces of the incoming supply of breathing gas, moving the seal 126 back onto, or close to, the seal seat 128. The flow regulation mechanism 120 is now returned to the closed or nearly-closed configuration, where the cycle can repeat.

When the user disconnects the regulator 100 from the face mask 18, there is no longer a need to supply breathing gas to the regulator 100. Some lung demand regulators include a manual shutoff button which discontinues the flow of breathing gas. Users may not remember to activate the shutoff and therefore breathing gas may continue to flow and be wasted. The present disclosure includes an automatic lockout mechanism 105 (auto-lockout mechanism 105) which automatically moves the flow regulation mechanism 120 into the closed configuration when the user disconnects the regulator 100 from the face mask 18.

In this example, the auto-lockout mechanism 105 comprises three components: a retention lever 160, a lockout actuator 150 and a lockout lever 190. The retention lever 160 is configured to pivot on substantially the same plane as the flow regulation lever 170 about the retention lever pivot 166. The distal end of the retention lever 160, furthest from the retention lever pivot 166, lies on the top surface of the flow regulation lever foot 172. A holding element 162 of the retention lever 160 on the opposite side of the retention lever pivot 166 interacts with a spring 164 to bias the retention lever 160 to two positions at either end of the range of motion of the retention lever 160. The two positions correspond to locked and unlocked.

When the auto-lockout mechanism 105 is activated, the retention lever 160 is in the locked position, and when the auto-lockout mechanism 105 is deactivated, the retention mechanism 160 is in the unlocked position.

The lockout lever 190 comprises a lever stop 194 and a lever finger 192. The lockout lever 190 pivots about the lockout lever pivot 196 on substantially the same plane as the flow regulation lever 170 and retention lever 160.

As the lockout lever 190 rotates anticlockwise as shown in FIG. 3A, the lever finger 192 contacts the retention lever 160. As the lockout lever 190 continues to push on the retention lever 160, the retention lever 160 contacts the top surface of the flow regulation lever foot 172. As the lockout lever 190 rotates further still, it begins to cause the flow regulation lever 170 to rotate in a clockwise direction as shown in FIG. 3A. This results in the flow regulation mechanism 120 being moved towards its closed configuration. During this rotation of the flow regulation lever 170, the diaphragm 106 is pushed outwards by the flow regulation lever foot 172.

Eventually, the lockout lever 190 moves the flow regulation lever 170 and retention lever 160 far enough to engage the biasing of the holding element 162 and spring 164, thus activating the auto-lockout mechanism 105 and locking-out the flow regulation lever 170 and the diaphragm 106 in the closed position. In some examples, a detent may be provided to secure the retention lever 160 in the locked position.

The auto-lockout mechanism can be automatically deactivated by the user inhaling. Inhalation causes the diaphragm 106 to move inwards, resulting in the flow regulation lever 170 and retention lever 160 rotating anticlockwise. The biasing of the holding element 162 and spring 164 (and/or detent if present) is overcome and the retention lever 160 is moved to its unlocked position.

The lever stop 194 of the lockout lever 190 is configured to limit the maximum permissible rotation of the lockout lever 190 by contacting the body of the regulator 100 when the limit is reached. In many examples, this limit will be set at the point where the lockout lever 190 can rotate just far enough to activate the auto-lockout mechanism and thus set the flow regulation mechanism 120 in the closed configuration. The limit may also be set at a point prior to undue tension being applied to the diaphragm 106 by the flow regulation lever 170.

Rotation of the lockout lever 190 is caused by the lockout actuator 150 pushing the lockout lever 190 at a position between the lockout lever pivot 196 and the lever finger 192. This converts the linear force delivered by the lockout actuator 150 into a turning moment of the lockout lever 190. The lockout actuator 150 contacts the lockout lever 190 at a first position on the lockout lever 190. The lever finger 192 contacts the retention lever 160 at a second position on the lockout lever 190. The distance between the first position and the lockout lever pivot 196 is a first distance. The distance between the second position and the lockout lever pivot 196 is a second distance. The ratio between the first distance and second distance determines the size of the travel distance of the lever finger 192 compared to the travel distance of the lockout actuator 150, as well as the magnitude of the force translated.

Presently disclosed, the first and second distances on the lockout lever 190 result in a magnification of the travel distance and a diminishment of the force translated. This configuration may aim to ensure the flow regulation lever 170 and retention lever 160 can be moved far enough, while limiting the chance of damage occurring to the diaphragm 106.

The lockout actuator 150 is positioned to operate between the regulator chamber 103 and the ambient atmosphere, passing through the body of the regulator 100. A seal 152 is used to maintain isolation between the atmosphere of the regulator chamber 103 and the ambient atmosphere.

The lockout actuator 150 is moved by the two release elements 140. Shown more clearly in FIG. 3B, the release elements 140 each include a cam element 146 with a first chamfered face and the lockout actuator 150 includes a cam follower 154 with a second chamfered face.

As the release elements 140 are pressed together by the user (as shown in FIG. 3B), the space between the cam elements 146 reduces, engaging the cam follower 154 and causing the cam follower 154 to move up the chamfer of the cam elements 146. This translates the force applied to the cam elements 146 by the user to the lockout actuator 150. The lockout actuator 150 moves in a direction substantially parallel to the longitudinal axis of an outlet port 102.

In the present disclosure, the angles of the chamfers of the cam elements 146 and cam follower 154 are substantially complimentary so as for the surfaces of the chamfers to be parallel. The resulting arrangement may effectively translate the force between the cam elements 146 and cam follower 154, while reducing the chance of the cams catching. In other examples, the angles of the first and second chamfers may not complement each another. In other examples still, only the cam elements 146 or cam follower 154 may comprise a chamfered face. In these alternative examples, the force may still be translated therebetween.

The cam elements 146 and cam follower 154 may be made from the same or different materials. The same or different materials may have a suitably low coefficient of friction to ensure the cam elements 146 and cam follower 154 can slide past each other with suitably low resistance. The same of different materials may also be suitably resistant to repeated abrasive contact. In lung demand regulators with moving parts, reliable operation is important. Friction between parts may be minimised to reduce wear.

The release elements 140 in the present disclosure are movable in a substantially radial direction relative to a longitudinal axis of the outlet port 102 of the flow regulation mechanism 120. In other examples, the release elements 140 may be movable in a different direction, for instance parallel to the longitudinal axis or circumferential tot he outlet port 102.

The release elements 140 are buttons on the outside of the regulator 100. Buttons of this type may have a high grip surface finish, for instance rubber, to ease operation for the user. If, as in the present disclosure, a regulator 100 has two release elements 140, they may be positioned on opposite sides of the regulator 100 so the user can press both simultaneously using one hand. Alternative examples may have a different number of release elements with different placements.

In this example, the release elements 140 are biased so as to return to their inactive (unpressed) position once the user releases them. A spring element may act upon the release elements 140 to provide a suitably resistive force to reduce the likelihood of accidental actuation. The resistive force may, for example, be derived from a spring, or from the force exerted by the diaphragm 106.

Shown in FIG. 3C, the two release elements 140 also each comprise a first keying element 142.

The first keying elements 142 include one protrusion and one depression. The second keying element 144 on the face mask 18 also includes one protrusion and one depression. The protrusions of the first keying elements 142 are of substantially similar height to the depth of the depression of the second keying element 144, and the protrusion of the second keying element 144 is of substantially similar height to the depth of the depressions of the first keying elements 142. Therefore, the first keying elements 142 and second keying element 144 are able to lock together securely.

In other examples, the first keying elements 142 may comprise more than one protrusion and more than one depression which are configured to complement a complementary second keying element 144 on a face mask 18 to which the regulator 100 may be connected.

The first keying element 142 and the second keying element 144 are configured to permit rotation of the regulator 100 about the longitudinal axis relative to the face mask 18. In the present disclosure, the second keying element 144 is an annular shape with a continuous cross section profile, thus allowing the first keying elements 142 to interface with the second keying element 144 at any point around the circumference. Given this freedom to interface at any orientation, the regulator 100 can rotate relative to the face mask 18 about the longitudinal axis.

In the present disclosure, the regulator 100 transfers breathing gas to the face mask 18 via the outlet port 102. The outlet port 102 is substantially circular in plan. This permits the regulator 100 to rotate about the outlet port 102. However, alternative examples may use different shaped outlet ports. Other examples of lung demand regulators may not include an outlet port, and instead interface with an inlet port on a face mask. The outlet port 102 is configured with a sealing ring 104 to substantially prevent breathing gas from escaping from the connection between the outlet port 102 and the face mask 18.

The first keying elements 142 each also comprise a chamfered section configured to contact the second keying element 144 so as to automatically actuate the release elements 140 when the regulator 100 is pushed onto the face mask 18. The force applied when pushing the regulator 100 onto the face mask 18 actuates the release elements 140 by converting the force substantially parallel with the longitudinal axis to a force substantially radial to the longitudinal axis via the interfacing of the chamfered sections and the second keying element 144.

In some examples, a chamfered section may instead be located on the second keying element 144, or on both the first keying elements 142 and second keying element 144. In further examples, neither the first keying elements 142 nor the second keying element 144 may comprise a chamfered section. It should be understood that in these examples, the user would be required to press in the release elements 140 before pushing the regulator 100 on to the face mask 18.

The user removes the regulator 100 from the face mask 18 by pressing the release elements 140. This disengages the first keying elements 142 from the second keying element 144, so the regulator 100 can be removed from the face mask 18. At the same time, pressing the release elements 140 causes a force to be translated to the lockout actuator 150 via the cam elements 146 and cam follower 154. The movement of the lockout actuator 150 causes the lockout lever 190 to rotate, which in turn causes the flow regulation lever 170 and retention lever 160 to rotate. This results in the flow regulation mechanism 120 moving to the closed configuration and the retention lever being held in the locked position—automatically disabling the flow of breathing gas.

The regulator 100 of the present disclosure may provide a more convenient and less wasteful mechanism for automatically disabling the flow of breathing gas through the regulator 100 when the user connects or disconnects the regulator 100 from the face mask 18.

As the flow of breathing gas can be controlled automatically by the user connecting or disconnecting the regulator 100 from the face mask 18, there is a reduced likelihood of breathing gas being wasted. A cam element 146 and cam follower 154 arrangement is used to operably connect the release elements 140 to the auto-lockout mechanism 105. This cam element 146 and cam follower 154 arrangement may result in an improvement in reliability as the number of moving parts may be reduced compared to other arrangements. Further, the responsiveness of the mechanism may be improved by reducing the number of components between which force may be translated. As a result of using a reduced number of components, the arrangement may be more compact and fit into a smaller space inside the regulator 100. As a result, manufacturing of the regulator 100 may be simplified, lifespan may be improved, and/or the overall size of the regulator 100 may be reduced.

As the flow of breathing gas can also be enabled automatically by the user inhaling, the regulator 100 of the present disclosure is easy and convenient to use, with reduced opportunity for user error.

It should be appreciated that the exemplary arrangement disclosed is one of many possible configurations for automatically disabling the supply of breathing gas when the lung demand regulator is disconnected from the face mask, using a cam and follower arrangement. Where another automatic disablement configuration is used, it should be understood that the principles of the present disclosure could be applied and adapted to provide an automatic disablement of breathing gas flow.

1. A lung demand regulator for a breathing apparatus comprising:
a flow regulation mechanism for regulating a flow of breathing gas, the flow regulation mechanism having a closed configuration in which breathing gas flow can be substantially prevented;
a connection mechanism for releasably connecting the lung demand regulator to a face mask, the connection mechanism comprising at least one movable release element configured to be manually actuated by a user to release the connection mechanism;
and a lockout mechanism for locking the flow regulation mechanism in the closed configuration, the lockout mechanism configured to be activated by the at least one release element, the lockout mechanism comprising a lockout actuator configured to activate the lockout mechanism, wherein the at least one release element comprises a cam element and the lockout actuator comprises a cam follower configured to engage with the cam element, such that the lockout actuator is actuated by movement of the at least one release element.

2. A lung demand regulator as claimed in claim 1, wherein the at least one release element is movable in a substantially radial direction relative to a longitudinal axis of an outlet port of the flow regulation mechanism.

3. A lung demand regulator as claimed in claim 2, wherein the substantially radial movement of the at least one release element is configured to be translated by the cam element and cam follower into a movement of the lockout actuator in a direction substantially parallel to the longitudinal axis.

4. A lung demand regulator as claimed in claim 3, wherein the cam element is configured with a first chamfered face and, optionally wherein the cam follower is configured with a second chamfered face, optionally wherein the planes of the first chamfered face and second chamfered face being substantially parallel to each other.

5. A lung demand regulator as claimed in claim 3, comprising first and second cam elements configured to move in substantially opposing directions to engage the cam follower.

6. A lung demand regulator as claimed in claim 1, wherein the lockout mechanism comprises a lockout lever configured to be pivotable about a first pivot, wherein the lockout actuator is configured to interface with the lockout lever such that movement of the lockout actuator pivots the lockout lever about the first pivot.

7. A lung demand regulator as claimed in claim 6, wherein the lockout mechanism comprises a diaphragm retention lever configured to be pivotable about a second pivot.

8. A lung demand regulator as claimed in claim 7, wherein the lockout lever is configured to interface with the diaphragm retention lever such that pivoting movement of the lockout lever pivots the diaphragm retention lever about the second pivot.

9. A lung demand regulator as claimed in claim 8, wherein the lockout actuator is configured to interface with the lockout lever at a first position on the lockout lever a first distance from the first pivot, and the lockout lever is configured to interface with the diaphragm retention lever at a section position on the lockout lever at a second distance from the first pivot, wherein the second distance is greater than the first distance.

10. A lung demand regulator as claimed in claim 1, wherein the at least one release element comprises a first keying element.

11. A lung demand regulator as claimed in claim 10, wherein the first keying element is configured to interface with a substantially annular second keying element on the face mask.

12. A lung demand regulator as claimed in claim 11, wherein the first keying element and the second keying element are configured to permit rotation of the lung demand regulator about the longitudinal axis relative to the face mask.

13. A lung demand regulator as claimed in claim 10, wherein the first keying element comprises a chamfered section configured to contact the second keying element so as to automatically actuate the at least one release element when the lung demand regulator is pushed onto the face mask.

14. A breathing gas delivery system comprising a lung demand regulator according to claim 1, and a face mask for connection to the lung demand regulator.

15. A breathing apparatus comprising a lung demand regulator according to claim 1.

16. A breathing apparatus comprising a breathing gas delivery system according to claim 14.
